(19) United States
(12) Patent Application Publication
(10) Pub. No.: US 2026/0276090 A1
(43) Pub. Date: Sep. 17, 2026

(54) Dosing Valve

(71) Applicant: Buerkert Werke GmbH & Co. KG, Ingelfingen (DE)

(72) Inventors: Rainer Künzler, Ingelfingen (DE); Christian Hartmann, Ingelfingen (DE); Daniel Amon, Ingelfingen (DE); Ralf Egner, Ingelfingen (DE); Johannes Baumann, Ingelfingen (DE); Ralf Scheibe, Ingelfingen (DE)

(21) Appl. No.: 19/568,238

(22) Filed: Mar. 16, 2026

(30) Foreign Application Priority Data
Mar. 14, 2025 (DE) 10 2025 109 987.1

(51) Int. Cl. F16K 7/16; F16K 31/10

(52) U.S. Cl. CPC F16K 7/16; F16K 31/10

(57) ABSTRACT

A dosing valve is provided with a valve body having an inlet opening and an outlet opening which extend from a common overflow chamber in the valve body, and a diaphragm which delimits in sections the overflow chamber and is movable between an open and a closed position. In the closed position, the diaphragm rests on at least one valve seat in the overflow chamber and prevents flow from the inlet opening to the outlet opening, wherein the diaphragm is clamped between the valve body and a retaining part and a single-arm actuating lever is provided, which is pivotably mounted on the valve body or the retaining part via a bearing pin and to which the diaphragm is attached and which moves the diaphragm between the positions onto and away from the at least one valve seat.

### CROSS REFERENCE TO RELATED APPLICATION

This application claims priority from German Patent Application Serial No. 10 2025 109 987.1, Filed Mar. 14, 2025, the contents of which are incorporated herein by reference.

### TECHNICAL FIELD

The specification relates to a dosing valve comprising a valve body having an inlet opening and an outlet opening which extend from a common overflow chamber in the valve body, and a diaphragm which delimits in sections the overflow chamber and is movable between an open and a closed position, wherein in the closed position, the diaphragm rests on at least one valve seat in the overflow chamber and prevents flow from the inlet opening to the outlet opening, wherein the diaphragm is clamped between the valve body and a retaining part.

### BACKGROUND OF THE INVENTION

Such dosing valves are usually extremely small and have a total volume of less than 10 cm³, often less than 7 cm³, and are used to dose very small quantities of liquid, e.g., in the pharmaceutical sector. Such dosing valves often require extensive adjustment to set them accurately. In addition, these dosing valves are often provided with many and correspondingly small components, so that the valves are also prone to errors during assembly.

There are dosing valves in which the actuator for actuating the diaphragm has a guide, which may lead to a variable service life of the dosing valve. Furthermore, such dosing valves often do not have proportional opening behavior, i.e., when the electrical energy supplied to the electric actuator increases, an opening behavior proportional thereto cannot be expected.

It is an object to improve a dosing valve such that the adjustment effort is reduced and the dosing valve can be switched very precisely.

### SUMMARY OF THE INVENTION

The disclosure provides a dosing valve, comprising a valve body having an inlet opening and an outlet opening which extend from a common overflow chamber in the valve body, a diaphragm which delimits in sections the overflow chamber and is movable between an open and a closed position, wherein in the closed position, the diaphragm rests on at least one valve seat in the overflow chamber and prevents flow from the inlet opening to the outlet opening, wherein the diaphragm is clamped between the valve body and a retaining part and a single-arm actuating lever is provided, which is pivotably mounted on the valve body or the retaining part via a bearing pin and to which the diaphragm is attached and which moves the diaphragm between the positions onto and away from the at least one valve seat.

A single-arm lever has the advantage that, in conjunction with its own bearing pin, it remains precisely and permanently positioned, can be switched quickly, and does not require any adjustment effort.

The solutions known in the prior art with a rocker arm (also called a rocker), in which an opening is provided for each arm which can be opened and closed via the rocker arm, require significantly more adjustment effort, and in addition, the switching accuracy is poorer than that of the disclosure. Such rocker lever variants are predominantly used in 3/2-way valves, in which a central inlet or outlet opening is usually located in the middle between the two openings. These rockers are also used in pumps, in which fluid is pumped into the overflow chamber by alternately opening and closing the inlet and outlet opening and is then ejected therefrom.

Such valves are not used as dosing valves, as the inflow or outflow takes place via two openings.

A dosing valve is not a pump, but requires a pressurized fluid so that it can also flow through the open dosing valve. However, the dosing valve opens and closes very precisely to deliver a desired amount of fluid, and after this predetermined amount of fluid has been delivered, the dosing valve is closed.

The solution according to the disclosure comprising the provided bearing pin on which the valve body is pivotably mounted, ensures that the position tolerances for the diaphragm are minimal, in contrast to, for example, a solid joint, which additionally involves higher manufacturing costs.

The dosing valve according to the disclosure usually comprises an electromagnetic drive which drives the actuating lever.

This electromagnetic drive can move to stable intermediate positions between the open and closed position, so that the dosing valve can be designed to be positionally stable.

According to one variant of the disclosure, the drive is a Lorentz force drive. In such a Lorentz force drive, an air coil and one or more permanent magnets cooperate to move a part. According to one variant of the disclosure, an air coil mounted on the actuating lever is part of the Lorentz force drive, and at least one stationarily mounted permanent magnet is adjacent to the air coil. When the air coil is energized, it moves relative to the permanent magnet and thus pivots the actuating lever.

The actuating lever may be spring-loaded into a pivoted position so that the actuating lever can be moved in this direction when the Lorentz force drive is no longer effective or is no longer sufficiently effective. The spring used for this purpose is for example a pressure-loaded spiral spring, which is characterized by a high stability and a precise spring characteristic.

The dosing valve is a 2/2-way valve. The diaphragm can only close either the inlet opening or the outlet opening, and the other of the openings always remains open, which simplifies adjustment and increases switching accuracy.

The actuating lever may have two legs which are aligned with each other in an L-shape. The bearing pin is located at an axial end of a leg and the diaphragm is located in the space enclosed by the two legs, which greatly improves compactness.

In addition, this variant allows the sealing surface of the diaphragm (relative to the closed state of the dosing valve), which forms a plane, to be positioned so that the central axis of the pin lies in this plane. The valve seat is therefore also located in this plane. This ensures that in the last phase of the closing movement or in the first phase of the opening movement, the movement of the diaphragm is perpendicular to the valve seat, so that opening or closing occurs abruptly and there is no partial gap between the diaphragm and the valve seat. This would in fact occur if contact between the diaphragm and the valve seat already existed or still existed at certain points.

The attachment of the diaphragm to the actuating lever is important because the movement of the actuating lever should be directly converted into a movement of the diaphragm to optimize the positioning accuracy and thus the switching accuracy and, in turn, the dosing accuracy. In the disclosure, the diaphragm can be fastened to the actuating lever in a non-destructively detachable manner, for example by a form fit. This makes the diaphragm a replaceable part. Alternatively, the diaphragm may of course also or additionally be vulcanized onto the actuating lever.

For form-fitting attachment, it is possible to have a mushroom-like fastening projection protruding from the actuating lever. The diaphragm has a receptacle which is complementary thereto and receives the fastening projection. Alternatively, a fastening projection having a groove provided on the circumference may be provided on the fastening lever, which accommodates a complementary thickening on the diaphragm.

The fastening projection is, for example, a separate part attached to the actuating lever or a projection molded integrally on the actuating lever, in any case a part or section which is easy to manufacture.

The diaphragm may also have a sleeve-like extension which forms the complementary receptacle.

A securing sleeve optionally supports the diaphragm radially outwards in the area of the axial end of the sleeve-like extension, thus preventing the diaphragm from expanding in this area under load and possibly detaching from the actuating lever.

An alternative variant provides that the diaphragm has a sealing surface for contacting the valve seat and, on the rear side of the sealing surface, a fastening extension which extends into a receiving opening in the actuating lever to mount the diaphragm on the actuating lever.

In this context, the fastening extension may have a thickening with which it engages into an undercut in the receiving opening to fasten the diaphragm axially without play to the actuating lever. This absence of axial play is desirable so that a defined and reproducible switching movement can be ensured.

If either the valve seat of the inlet opening or of the outlet opening is aligned centrally with the diaphragm so that the diaphragm has a central section resting against the valve seat in the closed position, this enables constant pressure application across the entire valve seat on the one hand, and simultaneous contacting and lifting of the diaphragm at the valve seat across the entire circumference of the valve seat on the other hand. In addition, the diaphragm is loaded evenly, which increases the service life thereof.

The diaphragm may have a disc-shaped section, i.e., form a circular disc in a top view, which simplifies the manufacture thereof and enables the aforementioned even contact with the valve seat.

Two beads surrounding the disc-shaped section at the edge and protruding axially from the disc-shaped section are also part of the diaphragm. One bead is provided on the side facing the valve seat and protrudes axially here, and one bead is provided on the side facing away from the valve seat. The bead facing the valve seat limits the overflow chamber laterally.

Reproducibility is particularly important for dosing valves, i.e., the diaphragm must switch very quickly on the one hand and always behave in the same way on the other hand. It has been found that these properties can best be achieved with a rigid diaphragm, which in turn results in that in tests, small and relatively thick diaphragms showed clear advantages over larger-volume, thinner diaphragms. To this effect, according to one variant, the disclosure provides that the diaphragm has an outer diameter in the range of 5 to 9 times the inner diameter of the inlet opening or outlet opening enclosed by the valve seat. This means that the diaphragm is relatively small compared to the outlet opening or the inlet opening, depending on which opening it opens and closes.

In addition or as an alternative thereto, the thickness of the diaphragm at the thinnest point thereof should be between 0.2 and 0.8 times the inner diameter of the inlet opening or outlet opening enclosed by the valve seat. This means that the diaphragm is thick and therefore rigid compared to previous diaphragms, which is disadvantageous in terms of the force to be applied but advantageous in terms of the reproducibility of identical strokes.

### BRIEF DESCRIPTION OF THE DRAWINGS

FIG. 1 shows a cross-sectional view through a variant of the dosing valve according to the disclosure in the area of the inlet and outlet opening,

FIG. 2 shows a view of part of the dosing valve according to FIG. 1 with the connected electromagnetic drive,

FIG. 3 shows a sectional view through a variant of the actuating lever including the diaphragm used in the disclosure,

FIG. 4 shows a sectional view of an alternative actuating lever including a diaphragm,

FIG. 5 shows a sectional view of a further alternative of the actuating lever including a diaphragm,

FIG. 6 shows another sectional view of an alternative actuating lever including a diaphragm, and

FIG. 7 shows an enlarged sectional view of a detail of a further actuating lever including a diaphragm.

### DETAILED DESCRIPTION OF THE INVENTION

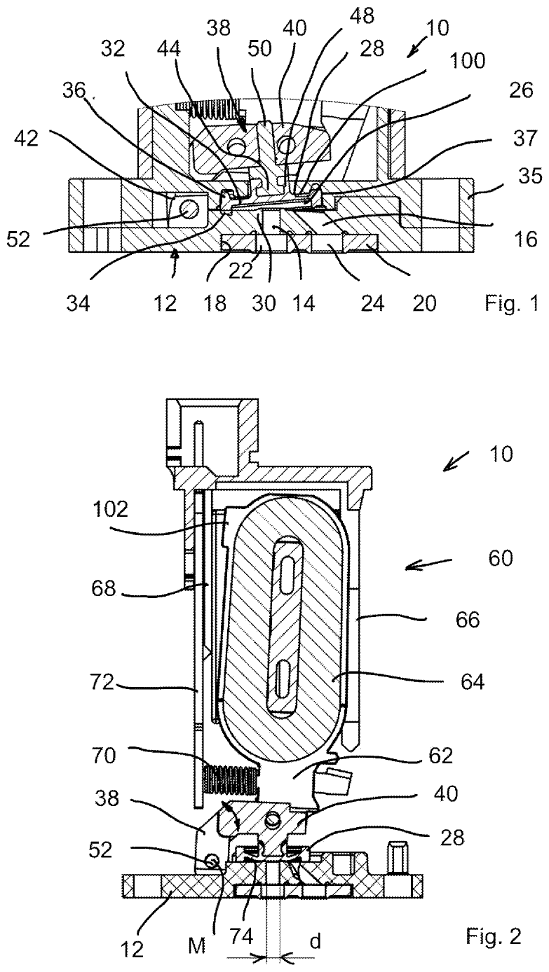

FIG. 1 shows part of a dosing valve 10, which is designed as a diaphragm valve and has a valve body 12, comprising an inlet opening 14 and an outlet opening 16, which however can also be reversed.

A recess 18 is provided on the underside of the valve body 12, into which an insert 20 is inserted, which has connection openings 22, 24 that are enlarged relative to the inlet opening 14 and the outlet opening 16, respectively, but are respectively aligned therewith.

The insert 20 is for example made of an elastomer and protrudes slightly beyond the underside of the valve body 12, more specifically in the area of annular sealing extensions which respectively surround the connection openings 22, 24 and protrude downwards.

On the upper side of the valve body 12, this defines in sections an overflow chamber 26 together with a diaphragm 28 made of elastomeric material.

Around the mouth of the inlet opening 14, an annular extension which forms the so-called valve seat 30, protrudes into the overflow chamber 26.

In a top view, the diaphragm 28 is disc-shaped and has a disc-shaped section 32 and, at the edge of the disc-shaped section 32, a bead 34 which is associated with the valve body 12 and thus with the side of the valve seat 30, as well as a bead 36 extending in the opposite direction. Both beads 34, 36 run closed around the circumference.

The lower end of the bead 34 always touches the upper side of the valve body 12, regardless of the valve position of the dosing valve 10, and thus limits the overflow chamber 26 laterally, whereas the disc-shaped section 32 limits the overflow chamber 26 on the side opposite the valve body 12.

On the edge side, the diaphragm 28 is clamped axially between a retaining part 35 and the valve body 12 at the beads 34, 36. The retaining part 35 has a groove 37 in which the bead 36 is received.

The diaphragm 28 is connected at the rear in a form-fitting manner to a single-arm actuating lever 38, which is L-shaped and has two legs 40, 42 forming the L.

In the embodiment shown, the L-shaped actuating lever 38 surrounds the diaphragm 28, which is located, so to speak, in the space enclosed by the L.

The diaphragm 28 is fastened to the actuating lever 38 in a non-destructively detachable manner by a form fit, in that a mushroom-like fastening projection 44 is received in a complementary receptacle on the rear side of the diaphragm 28. In this area, the diaphragm 28 has an integrally formed sleeve-shaped extension 48, which has the complementary receptacle.

In the variant shown in FIG. 1, the fastening projection 44 is molded onto a separate part 50 attached to the actuating lever 38, which is inserted into an opening in the leg 40 and has an axial stop to precisely define the axial position of the part 50.

The leg 42 has an opening in the area of the lower end thereof through which a bearing pin 52 extends to form a pivot bearing for the single-arm actuating lever 38.

The bearing pin is mounted on the valve body 12 or on the retaining part 35.

The retaining part 35 has a corresponding recess for receiving the diaphragm 28, as can be seen in FIG. 1.

In the variant shown, the bearing pin 52 is mounted in the retaining part 35 without play.

As can also be seen in FIG. 1, the inlet opening 14 is exactly aligned with the part 50, i.e., the movement of the part 50 is transmitted directly towards the valve seat 30 in the closed state, and the force is transmitted exactly to the valve seat 30 when the dosing valve 10 is closed.

The dosing valve 10 is a 2/2-way valve in which the diaphragm 28 can only open and close one of the two openings, in the present case only the inlet opening 14, whereas the other opening, in the present case the outlet opening 16, always remains open.

The dosing valve 10 is actuated by an electromagnetic drive, which can be seen in FIG. 2 and is designed as a Lorentz force drive 60. For better illustration, the outer housing surrounding the Lorentz force drive 60 and connected to the valve body 12 has been omitted.

The Lorentz force drive 60 allows positionally stable intermediate positions between the fully open and fully closed positions to be reached.

A coil carrier 62 in the form of a plate-shaped part which protrudes upward and carries an air coil 64 which can be energized is fastened to the leg 40. The coil carrier 62 is for example made of a non-soft magnetic material, e.g., plastic.

Permanent magnets 66, 68 on both sides of the air coil 64 and spaced apart therefrom ensure that, when the air coil 64 is energized, the air coil swings to the left and right, thereby pivoting the actuating lever 38 around the bearing pin 52 in the direction of the arrow.

The actuating lever 38 is spring-loaded via a compression spring 70 into a pivoting position, in the present case the closed position, by the spring 70 being tensioned between a holder 72 and the coil carrier 62. It is therefore a normally closed valve.

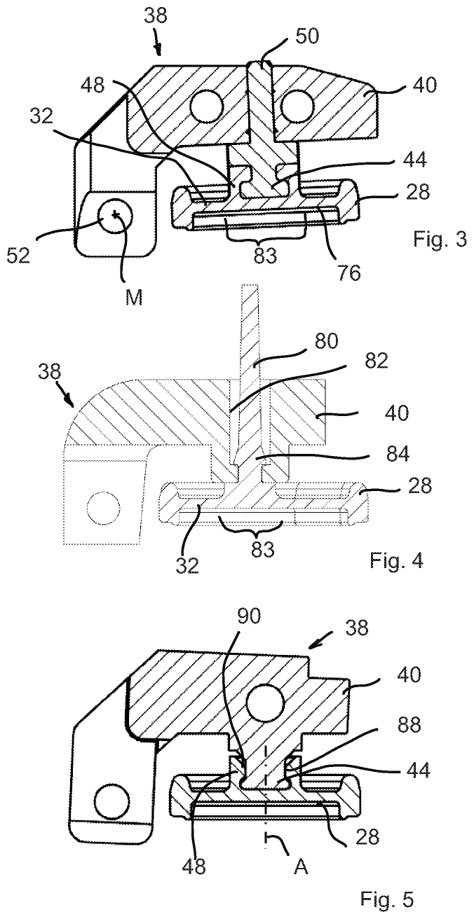

FIG. 2 also shows that, in the closed state of the dosing valve 10, the diaphragm 28 defines a flat sealing surface 74 on its underside, in which the central axis M of the bearing pin 52 lies. FIG. 3 shows this plane 76 (the underside of the disc-shaped section 32).

FIG. 3 shows an enlarged view of the unit consisting of the actuating lever 38, the diaphragm 28, and the part 50.

The sleeve-like extension 48 is located at the rear side of a sealing surface 83 with which the diaphragm 28 contacts the valve seat 30.

As the diaphragm 28 is circular disc-shaped and has a central section resting against the valve seat 30, the central section is here also the sealing surface 74 or comprises the sealing surface.

FIG. 4 shows a variant of how the diaphragm 28 can be fastened to the leg 40.

Here, the diaphragm 28 has a fastening extension 80 on its rear side, which extends through a receiving opening 82 in the leg 40 that widens into a step.

The fastening extension 80 is located on the rear side of the sealing surface 83 with which the diaphragm 28 contacts the valve seat 30.

The diaphragm 28 is not circular disc-shaped, but has a round shape that deviates from a circle in a top view, and has a central section resting against the valve seat 30. Here too, the central section is the sealing surface 74 or comprises the sealing surface.

The fastening extension 80 has a thickening 84 with which it engages into an undercut in the receiving opening 82 to mount the diaphragm 28 axially without play on the actuating lever 38. The undercut is formed by the aforementioned step in the widening receiving opening 82.

In the variant shown in FIG. 5, the actuating lever 38 has a downwardly projecting, mushroom-like fastening projection 44 which engages in a complementary receptacle in the diaphragm 28, here, as in FIG. 3, on a rearwardly projecting sleeve-like extension 48.

Here, the fastening projection 44 is integrally molded onto the leg 40. Conversely, it can also be said that the fastening projection 44 has a circumferential groove 88 into which a complementary thickening 90 of the diaphragm 28 protrudes.

The embodiment according to FIG. 7 is similar to that according to FIG. 5. To secure the diaphragm 28 against being pulled off the fastening projection 44, a securing sleeve 92 surrounds the sleeve-like extension 48 of the diaphragm 28 in the area of the thickening 90.

This prevents the thickening 90 from migrating out of the groove 88. The thickening 90 is provided in the area of the axial end of the sleeve-like extension 48, i.e., in the softest area of the sleeve-like extension 48.

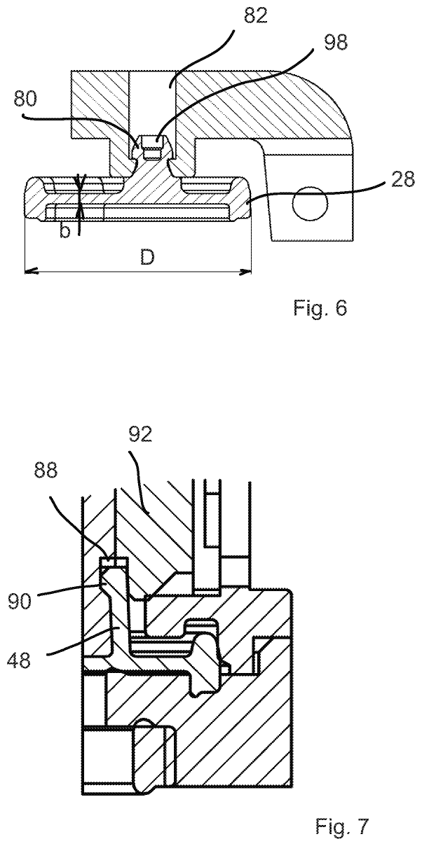

Similar to the embodiment shown in FIG. 4, the embodiment shown in FIG. 6 has a fastening extension 80 which protrudes on the rear side and comprises a thickening 84 which engages in the undercut formed by the stepped receiving opening 82. Here too, there is no axial play. The thickening 84 provides axial tensioning of the fastening extension 80 in the step of the receiving opening 82. An optionally provided axial opening in the fastening extension 80 increases the radial flexibility of the fastening extension 80 for insertion and engagement therein.

As shown in particular in FIG. 5, the diaphragm 28 can be aligned centrically with the valve seat 30, i.e., the disc-shaped section has a center point which coincides with the central axis of the valve seat in the closed state of the dosing valve, and preferably the central axis A of the valve seat 30 also coincides with the central axis of the fastening projection 44.

In all embodiments, the diaphragm 28 has an outer diameter D (see FIG. 6) which is in the range of 5 to 9 times the inner diameter d (see FIG. 2) of the opening enclosed by the valve seat 30, here the inlet opening 14.

The thickness b (see FIG. 6) of the diaphragm 28 at the thinnest point thereof in the unloaded state is between 0.2 and 0.8 times the inner diameter d of the opening enclosed by the valve seat 30, here the inlet opening 14, which makes the diaphragm 28 rigid, as it is designed to be small in external dimensions but relatively thick.

In the open position, the diaphragm 28 rests against the retaining part 35, as shown in FIG. 1. The area 100 forms the pivot stop for the diaphragm 28. The movement of the actuating lever 38 into the open position is limited by a stop defined by a lateral projection 102 on the coil carrier 62, which strikes, for example, the holder 72.

1. A dosing valve, comprising a valve body having an inlet opening and an outlet opening which extend from a common overflow chamber in the valve body, a diaphragm which delimits in sections the overflow chamber and is movable between an open and a closed position, wherein in the closed position, the diaphragm rests on at least one valve seat in the overflow chamber and prevents flow from the inlet opening to the outlet opening, wherein the diaphragm is clamped between the valve body and a retaining part and a single-arm actuating lever is provided, which is pivotably mounted on the valve body or the retaining part via a bearing pin and to which the diaphragm is attached and which moves the diaphragm between the positions onto and away from the at least one valve seat.

2. The dosing valve according to claim 1, wherein an electromagnetic drive which drives the actuating lever is provided.

3. The dosing valve according to claim 2, wherein the drive is a Lorentz force drive.

4. The dosing valve according to claim 3, wherein the Lorentz force drive has an air coil mounted on the actuating lever and wherein at least one stationarily mounted permanent magnet is adjacent to the air coil, wherein the air coil moves relative to the permanent magnet when the air coil is energized and pivots the actuating lever.

5. The dosing valve according to claim 1, wherein the actuating lever is spring-loaded into a pivoting position.

6. The dosing valve according to claim 1, wherein the dosing valve is a 2/2-way valve and the diaphragm can only close the inlet opening or the outlet opening, the other opening being always open.

7. The dosing valve according to claim 1, wherein the actuating lever has two L-shaped legs aligned with each other and the bearing pin is located at one axial end of one leg and the diaphragm is located in the space enclosed by the two legs.

8. The dosing valve according to claim 7, wherein the diaphragm has a sealing surface which forms a plane in which the central axis of the bearing pin is located.

9. The dosing valve according to claim 1, wherein the diaphragm is fastened to the actuating lever in a non-destructively detachable manner.

10. The dosing valve according to claim 9, wherein the diaphragm is fastened to the actuating lever by a form fit.

11. The dosing valve according to claim 9, wherein a mushroom-like fastening projection protrudes from the actuating lever and the diaphragm has a complementary receptacle which receives the fastening projection, or a fastening projection is provided on the actuating lever, having a groove provided on the circumference which receives a complementary thickening on the diaphragm.

12. The dosing valve according to claim 11, wherein the fastening projection is a separate part fastened to the actuating lever or an integrally molded projection.

13. The dosing valve according to claim 11, wherein the diaphragm has a sleeve-like extension which forms the complementary receptacle.

14. The dosing valve according to claim 13, wherein a securing sleeve is provided which radially supports the diaphragm outwards in the area of the axial end of the sleeve-like extension.

15. The dosing valve according to claim 9, wherein the diaphragm has a sealing surface configured for contacting the valve seat and, on the rear side of the sealing surface, a fastening extension which extends into a receiving opening in the actuating lever to mount the diaphragm on the actuating lever.

16. The dosing valve according to claim 15, wherein the fastening extension has a thickening with which it engages in an undercut in the receiving opening to fasten the diaphragm axially without play to the actuating lever.

17. The dosing valve according to claim 1, wherein either the valve seat of the inlet opening or of the outlet opening is aligned centrally with the diaphragm so that in the closed position, the diaphragm has a central section resting against the valve seat.

18. The dosing valve according to claim 1, wherein the diaphragm has a disc-shaped section and two axially protruding beads surrounding the disc-shaped section at the edge, wherein one bead protrudes axially on the side facing the valve seat and one bead protrudes axially on the side facing away from the valve seat, wherein the bead facing the valve seat limits the overflow chamber laterally.

19. The dosing valve according to claim 1, wherein the diaphragm has an outer diameter which is in the range of 5 to 9 times the inner diameter of the inlet opening or outlet opening enclosed by the valve seat.

20. The dosing valve according to claim 1, wherein the thickness of the diaphragm at the thinnest point thereof is between 0.2 and 0.8 times the inner diameter of the inlet opening or outlet opening enclosed by the valve seat.
